(19) United States
(12) Patent Application Publication
(10) Pub. No.: US 2008/0073546 A1
(43) Pub. Date: Mar. 27, 2008

(54) Enhanced magnetic particle steering

(75) Inventors: Per Andersson, Uppsala (SE); Gerald Jesson, Enkoping (SE)

Correspondence Address: BIRCH STEWART KOLASCH & BIRCH, PO BOX 747, FALLS CHURCH, VA, 22040-0747, US

(73) Assignee: GYROS PATENT AB, Uppsala (SE)

(21) Appl. No.: 11/717,056

(22) Filed: Mar. 13, 2007

Related U.S. Application Data
(60) Provisional application No. 60/781,337, filed on Mar. 13, 2006.

(30) Foreign Application Priority Data
Mar. 13, 2006 (SE) 0600557-3

(51) Int. Cl. H01J 1/50

(52) U.S. Cl. 250/396 ML

(57) ABSTRACT

The present invention relates to microfluidic systems using rotating microfluidic disc platforms comprising microchannel structures. More specifically, the present invention relates to a method and an arrangement for controlling magnetic particles in microchannel structures of a microfluidic device. The invention is based on the counterbalancing of the magnetic force and the centrifugal force on the beads when rotating the microchannel structures at different speeds close to an array of magnets.

### TECHNICAL FIELD

The present invention relates to microfluidic systems using rotating microfluidic disc platforms comprising microchannel structures.

More specifically, the present invention relates to a method and an arrangement for controlling the movement of magnetic particles/beads in a microchamber of a microchannel structure of a microfluidic device.

Particles may have different shapes and include round forms such as beads.

### BACKGROUND OF THE INVENTION

The term “microfluidic” refers to a system or device having one or a network of chambers and/or channels, which have micro scale dimensions, e.g., having at least one cross sectional dimension in the range from about 0.1 μm to about 1 μm such as to about 500 μm (depth and/or width). The term also refers to the fact that liquid volumes (aliquots) in the μl-range are transported and processed according to a predetermined protocol where the part of the network that is required for the protocol is called a microchannel structure. The μl-range includes the nl-range as well as the picolitre range. At least one of the aliquots contains at least one reactant, e.g. selected amongst analytes and/or reagents. See further below.

Microfluidic substrates and/or devices are often fabricated using photolithography, wet chemical etching, injection-molding, embossing, and other techniques similar to those employed in the semiconductor industry. The resulting devices can be used to perform a variety of sophisticated chemical and biological experiments including assays for the characterization of one or more analytes in a sample, separation experiments such as purification experiments, and experiments for the synthesis of organic and/or inorganic compounds such as bio-organic compounds.

Microfluidic analytical systems have a number of advantages over conventional chemical or physical laboratory techniques. For example, microfluidic systems are particularly well adapted for analyzing small sample sizes, typically making use of liquid samples having volumes in the μl-range. The microfluidic devices may be produced at relatively low cost, and the channels can be arranged to perform numerous analytical operations, including mixing, dispensing, valving, reactions, detections, electrophoresis, and the like on the same microfluidic device. The analytical capabilities of microfluidic systems and devices are generally enhanced by increasing the number and complexity of network channels, reaction chambers, and the like.

In the technique of using centrifugal forces to drive the fluid the microfluidic device typically is a disc that can be spun. Such discs are preferably circular and typically of the same physical format as conventional CDs (diameter around 12 cm), or rectangular. Liquid samples that are placed at an inner position relative to a spin axis can be transported to an outer position by centrifugal force created as the disc rotates, circumventing the need to design sophisticated electrokinetic or mechanical pumping structures. Capillary force, hydrostatic force created by the use of centrifugal force, etc can be used for transporting liquid from an outer position to an inner position (relative to a spin axis).

As will become evident in the forth-coming description the present invention is in particular applicable to (but not limited to) micro-analysis systems that are based on micro-channels formed in a rotatable, usually plastic, disc often called a “lab on a chip” or CD. Such discs can be used to perform analysis and/or separation involving small quantities of fluids as well as for the synthesis of inorganic and organic compounds.

Furthermore it is often desirable during the preparation of samples that the disc permits the user to dispense predetermined volumes of any desired combination of fluids or samples without modifying the disc. Suitable microanalysis channel structures for fluids provided in a rotatable disc are described e.g. in WO 01/46465 (Gyros AB), WO 02/074438 (Gyros AB), WO 02/075312 (Gyros AB), WO 97/21090 (Gamera), WO 98/53311 (Gamera), WO 00/79285 (Gamera), WO 98/28623 (Gamera), U.S. Pat. No. 6,752,961 (Abaxis), U.S. Pat. No. 5,693,233 (Abaxis) etc. A liquid transfer station has a robot that transfer at least one sample or any other predetermined liquid aliquot from the sample and reagent station to a microfluidic device, for instance in the form of a disc that can be spun. The station has means for transfer of liquid samples containing or not containing reactants, for instance a number of dispensing needles connected to syringe pumps or a number of solid pins may be used for the transfer of samples. Said needles and pins may be configured in different numbers of rows and columns having different distance between the tips in both directions. See for instance WO 97/21090 (Gamera), WO 01/19518 (Aclara) and the dispensing system used in Gyrolab Workstation (Gyros AB) (summarized in WO 02/075775 (Gyros AB)). Another alternative is the microdispensor described in WO 97/01085 (Pharmacia AB) and the dispensing systems presented in U.S. Pat. No. 6,338,820 (Alexion), US 2003/00965402 (Gyros AB) etc.

Mixing of different liquids in centrifugal-based microfluidic devices has previously been accomplished by spinning the device, for instance. This kind of mixing may take quite a long time, sometimes several minutes. However, it is already known to speed up the mixing time to a few seconds of time by using magnetic particles in a mixing chamber. The particles are exposed to a time-varying magnetic field that is generated by a fixed array of current-oscillating electromagnets. Another concept is earlier known from an article “Magneto-Hydrodynamic micromixing for centrifugal lab-on-a-disk platforms” by M Gruman et al, 8^{th} International Conference on Miniaturized Systems for Chemistry and Life Sciences (Malmö, Sweden), Sep. 25-30, 2004, pp. 593-595. For an optimum particle-enhanced mixing, a set of permanent magnets is equidistantly aligned in a lab frame. Their radial positions alternatingly deviate by a slight positive and negative offset from the mean orbit of the chamber. The particles are periodically deflected inbound and outbound during rotation. The known arrangement of magnets forces the particles in the mixing chamber to follow an “8”-formed trajectory during the spinning. See also Steigert et al., “Integrated sample preparation, reaction, and detection on a high-frequency centrifugal microfluidic platform” J. Assoc. Lab. Autom. October (2005), 331-341. Another prior art system, known from the Patent Application Publication US 2002/0025583 (Ellsworth et al), comprises an analytical rotor with a number of inlet chambers into which different liquids are introduced. Said inlet chambers are connected to a so called labelling chamber. In order to enhance mixing of fluid in said chamber, a mixing ball are introduced in the chamber. Said mixing ball is agitated by interaction with a plurality of fixed magnets disposed in a platform which lies beneath a rotor drive plate. The magnets are disposed in a pattern, so that the magnets alternate between the radially inner side of said chamber and the radially outer side of the chamber as the rotor is rotated. In this way, the magnetic balls will be caused to alternately move radially inwardly and radially outwardly as the rotor is spun.

There are microfluidic experimental protocols that involve particulate solid phase material that should gain from being used in suspended form in some steps and in sedimented form in other steps. There are also protocols in which further processing of a particulate solid phase requires that the solid phase is moved physically between different parts of a microchannel structure, for instance by bringing the liquid phase and the solid phase of a reaction mixture to separate part structures of the microchannel structure. In other words it should be advantageous to be able to easily pack and resuspend particulate solid phase material a predetermined number of times within a microchannel structure and/or to transport the particulate solid phase material selectively between different part structures of the same microchamber and/or microchannel structure.

When resuspending a sedimented bed for reaction between a particle-bound reactant and a dissolved reactant, there is a desire for an improved method that forces particles to more efficiently traverse the whole volume of the liquid.

Bed clogging may be disastrous when performing microfluidic experiments in which a liquid shall pass through a porous bed. This problem occurs due to presence of aggregates and/or various kinds of particulate material in the through-passing liquid.

The above-mentioned desires and problems can at least partly be met if magnetic particles are used as the particulate solid phase material and magnetic and centrifugal forces are used in combination for repeated suspending and/or sedimenting of the particles in a microchamber/particle pocket or for forcing the particles to traverse the liquid placed in the microchamber. Useful particle pockets are typically physically separated from or coincides with a liquid outlet. The prior art arrangements do not provide a sufficiently good particle steering protocol and arrangement to solve said problem

### BRIEF DESCRIPTION OF THE INVENTION

The invention is based on the counterbalancing of the magnetic force and the centrifugal force on the particles. The invention differs from known solutions in that the need for magnets forcing the particles outwards as described by M Gruman et al (Ibido) and Steigert et al (Ibido) is minimized and can be completely avoided if so desired. In a simple and very favourable variant all of the magnets are positioned closer to the spin axis than the particle microchamber, i.e. all magnets of Gruman et al that are at the outer radius of the microchannel structure are eliminated. The magnetic force is therefore only directed toward the inner radius of the disc (toward the centre of the disc or spin axis). The motion of the beads in radial inwards direction, i.e. inwardly against the disc centre or spin axis, or in radial outwardly direction, i.e. outwardly against the disc edge (circumference), is controlled by adjusting the disc rotation speed. The disc rotation speed affects the time that the magnetic particles are influenced by the magnetic field, i.e. the time and how frequently the particles contained in the microchamber pass close to the magnets. Moreover, the disc rotation speed creates a centrifugal force that directs the movement of the particles outwards, toward the outer radius or circumference of the disc (i.e. away from the magnets). Also up to a certain threshold for the disc rotation speed, for which the magnetic field is stronger than or equal to the centrifugal force, increasing disc rotation increases the speed at which particles are following the magnetic field, since the particles are more often influenced by the magnetic field. Depending on spin direction (clockwise or counter-clockwise) the beads can be moved in any angular/circumferential direction within the microchamber meaning that the particles in principle more efficiently can be forced to traverse all parts of the microchamber in a predetermined and controlled manner. An arbitrary part of the inner wall of the microchamber can be designed as a particle pocket or trap to which all or only a portion of the particles in the microchamber can be guided by the appropriate spin program.

In the context of the invention a pocket will be a part of the microchamber in which the particles are able to collect or trap when subjected to centrifugal force created by spinning the device. The part of the microchamber next to a pocket is typically closer to the spin axis utilized than the pocket as such. A lower part of a particle pocket may or may not contain an outlet for which is liquid present in the microchamber.

A preferred embodiment of the present invention is a method for controlling the movement of magnetic particles, e.g. magnetic beads, in a microchamber of a microchannel structure of a microfluidic device according to the independent claim 1.

Different embodiments of the invented method are defined by the dependent claims 2-16.

The present invention also refers to an arrangement for controlling the movement of magnetic particles, e.g. magnetic beads, in a microchamber of a microchannel structure of a microfluidic device in accordance with the independent claim 17.

Different embodiments of the invented arrangements are defined by the dependent claims 18-28.

The microchamber in which particles are to be moved in accordance to the invention has one or more particle pockets, one or more inlets for liquid and one or more outlets for air. A vent outlet may or may not function as an inlet or outlet for liquid. In the innovative method the magnetic particles are provided in a liquid aliquot or phase contained within the microchamber. The movement of the particles are taking place within this aliquot.

One object of the following description is to describe how different embodiments of the present invention accomplish specific particle motion, such as:
The radial motion of particles by counter balancing magnetic force and centrifugal force;
The lateral motion of the particles by choosing the direction of spinning;
The depth motion of the particles by placing magnets above and/or under the spin plane defined by the particle microchamber (disc/device plan);
The spreading of a particle cloud by controlling the distance between the magnet and the spin plane (i.e. the magnet and the microchamber).
   The present invention will now be described in more detail with reference to the following drawings.

### BRIEF DESCRIPTION OF THE DRAWINGS

FIG. 1 is a block diagram depicting schematically a microfluidic system.

FIG. 2 shows an arrangement of a microfluidic system.

FIG. 3 is a schematic drawing of a subset of microchannel structures on a microfluidic disc. Each structure has a microchamber with a particle pocket that coincide with a liquid outlet.

FIG. 4a is a schematic illustration of the arrangement according to the invention.

FIG. 4b is a side view of a cross-section along the line 4b-4b of the microfluidic disc attached on a spinner station and motor.

FIG. 5 is a drawing that illustrates an embodiment of a microchannel structure, an individual microlab, in which there is a particle pocket that is not associated with a liquid outlet.

FIG. 6 gives a structure with a particle microchamber that has a pocket with an outlet that permits downstream transportation of magnetic particle together with a minor part of the liquid in which the particles have been subjected to controlled movement.

FIG. 7 gives a particle microchamber with a pocket having a liquid outlet that permit retaining the magnetic particles while quickly flushing out the liquid in which the particles have been moved.

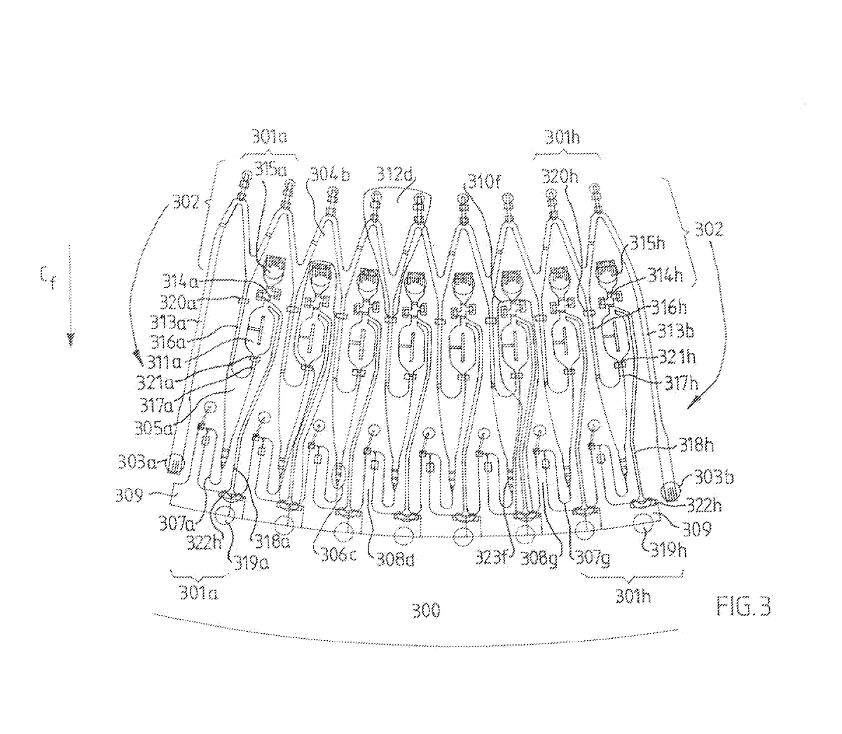

The first digit in reference numbers in FIGS. 3 and 5-7 refers to the number of the figure. Corresponding parts in these figures have in principle the same two last digits.

The direction of centrifugal force has been indicated by an arrow in each of FIGS. 3 and 5-7.

### DETAILED DESCRIPTION OF THE INVENTION

Different microfluidic systems are known. One type of systems comprises a controller unit and a microfluidic instrument. Such a system is called a Stand Alone System. Each system has its own data and operates completely stand alone. The interaction with the system may be performed at an associated Personal Computer (PC).

Another system can be considered as a group of instruments plus a common persistent storage location, e.g. database. Many instruments can operate on the same set of data (Method Data, Microfluidic Device Data, etc). All interactions with the system need to be performed at an instrument connected computer, a controller. This second system is often called a Distributed Database Solution.

In a third solution, the distributed solution, the system is considered as a group of instruments, a common storage persistent storage location (database), and a number of clients. With this solution the same functionality as in the above-mentioned Distributed Database Solution is reached. In addition there will be a possibility to interact with the system from non-instrument connected computers. Examples of additional provided functionality are:
Remote monitoring of instruments.
Perform functions that are not instrument specific (Method Development, Evaluation of processed data. Etc)
   With this third solution it is possible to control (Start, Pause, Abort) the processing remotely, that is, from a non-instrument connected computer.

An operator/user can control and monitor the performance of the microfluidic instrument from the controller. The microfluidic instrument comprises of a number of different stations, each station being capable of performing one or a number of defined operations. Different types of microfluidic instruments consist of different kinds of stations or number of stations. Therefore, some operations will not be provided for or applicable on a certain type of microfluidic instrument.

The operations are initiated from the controller.

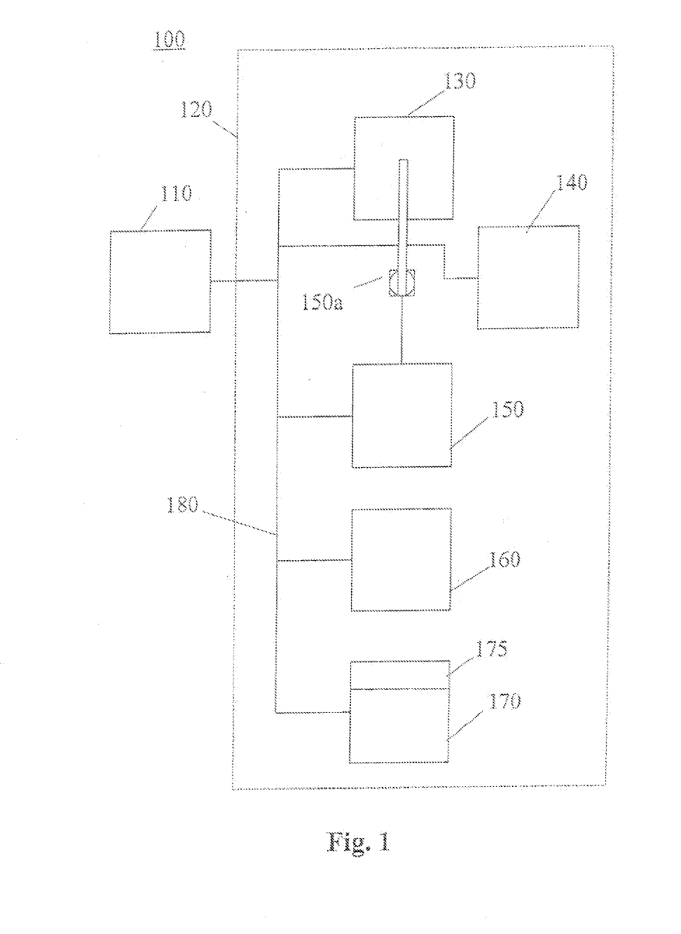

FIG. 1 is a block diagram depicting schematically a microfluidic system 100 that includes a) a control unit, also denoted controller, 110, and b) an instrument 120 comprising one or more of the following items:
i) a sample and reagent station 130,
ii) a wash station 140 for washing the liquid transfer or dispensation equipment,
iii) a liquid transfer station 150 for transfer of liquid samples to a microfluidic device,
iv) at least one station 160 for implementing transport of liquid within the microfluidic device e.g., a spinner station,
v) a liquid detector station 175 for detecting the presence/absence of a liquid and/or a gas phase in a liquid detection segment as an indication of proper liquid handling in a microchannel structure containing the segment, and
vi) a detector station 170, for collecting the signal reflecting the result of an experiment carried out in a microchannel structure of a microfluidic device via a detection area associated with the microchannel structure.

Some of the stations may be integrated with each other, for instance the liquid detector station 175 typically may be integrated with the station for implementing liquid transport within the device and/or with the detector station 170. An instrument according to the present invention at minimum comprises the liquid detector station 175 and the station for implementing liquid transport 160. For circular and/or rotatable microfluidic devices the liquid detector station 175 and/or the detector station 170 may incorporate a spinner/rotary function.

The signal collected in the detector station is typically radiation.

The controller 110 may be one or more computers outside the instrument and/or one or more central processors within the instrument. The controller is connected to the instrument 120 and its different stations via a conductor or data bus 180 and operation orders are typically transmitted either as electrical or optical signals or included in a suitable predetermined protocol to hardware circuits distributed between the stations.

A controller may comprise different control means, for instance electronic and programmable control means with operator's interface. Software, not further disclosed, may be assigned to a detector arrangement used for controlling:
(i) detecting presence or absence of a liquid phase and/or a gas phase in liquid detector segments as discussed above, and/or
(ii) collecting signals representing the result of an experiment via the above-mentioned detection areas.

These control means may be used when:
a) recognizing one or more pairs of start/stop-positions (angular and/or radial if the device is rotatable and/or circular) for irradiating if the detection principle utilized requires irradiation and/or for collecting the desired signal,
b) identifying individual subareas in detection areas or elsewhere in the surface of the disc, such as in the above-mentioned segments used for detecting failure in liquid handling,
c) controlling the movement of a microfluidic device and a detector head relative to each other, e.g. simultaneous rotating of the microfluidic device and incremental lateral/radial displacement of a detector head associated with any of the two detector arrangements discussed above (if the device is rotatable and/or circular),
d) collecting signal data from the detection areas/detection microcavities/liquid detection segments,
e) treatment and presentation of the collected data, and/or
f) determining the time at which a particular angular position is in front of the objective of a detector head from the rotational speed (if the device is rotatable).

Different parts of the instrument may communicate with the controller 110. The controller will in the preferred variants instruct a detector head to successively collect the signal from distinct and pre-selected parts of the surface of the disc if the detector station is according to US 2003/0054563 (Gyros AB), for instance. Typically the controller is programmed to start collecting signals at a position which is prior to an intended detection area/liquid detection segment, and to end the collecting at a position, which is after the same detection area/segment. If the collected signal requires irradiation, then the detector arrangement/head or some other means also should provide for such irradiation, which is the case if fluorescence, absorbance, reflection etc is measured. In this latter case the control means should also define the settings for the start and stop positions for irradiation. These latter settings are typically essentially the same as for collecting the signal.

The start and stop signals for collecting the signal representing the result of an experiment or the presence of liquid and/or gas in the liquid detection segment is preferably directly linked to positions in the microfluidic device at which collection of signal is to start and end, respectively. This also includes that due account is taken for delays that may be inherent in the system or preset, i.e., the start and stop signals may have to be initiated before the detector head is positioned in front of the start and stop position, respectively. If the microfluidic device is circular and/or rotatable, an angular aligning system within a spinner function may comprise an encoder, the encoder signals corresponding to a start position and a stop position are used to define the time period during which the signal is to be collected. In an alternative, the start and stop for collecting the signal is linked to a preset rotating speed, i.e., the controller calculates from a preset rotating speed the time at which the start and stop position should be in front of the detector head.

Further, the present system have a sample and reagent station 130 comprising means for storing samples, reagents or other liquids. Said samples, reagents or other liquids is stored in some kind of container, such as a micro plate or multiwell plate, a test tube rack or a test tube. Said plate is designed as a matrix of small containers or wells. Said plate can have different sizes depending on the number of wells. The container may be loosely fixed at a container holder, for instance a so-called carousel, which is a circular revolving plate.

The liquid transfer station 150 has a robot 150a that transfer at least one sample or any other predetermined liquid aliquot at a time from the sample and reagent station 130 to a microfluidic device, for instance in the form of a disc that can be spun. The station have means for transfer of liquid samples, and other liquids, for instance a number of injection needles connected to syringe pumps or a number of solid pins may be used for the transfer of samples. Said needles and pins may be configured in different numbers of rows and columns having different distance between the tips in both directions. Other alternatives have been discussed above under the heading “Background of the invention”.

Said needles and pins may or may not be washed in a wash solution between the transfers of samples and reagents. Washing is done by means placed in a wash station 140.

The liquids dispensed to a microfluidic device are transported within the device by means associated with the station 160 for implementing liquid transport. This station may be a spinner station in case the microfludic device is adapted to permit liquid transport caused by spinning. The result of a process carried out within the microfluidic device is determined by means for detecting (a detector) which is located in a detector station 170.

The arrangement of the detector station 170 is adapted for measuring signals reflecting the result of an experiment. The signals are typically measured via a detection area in the surface of the microfluidic device and typically derive from an underlying detection microcavity which is part of a microchannel structure. A useful detector arrangement is described in US 2003/0054563 (Gyros AB) and comprises:
(a) a detector head with a focal area, and a disc holder which are linked to a means enabling for the detector head, i.e., the focal area to transverse, the surface of the disc when the disc is placed in the disc holder.
(b) an aligning system for recognizing the position of the part area which at a particular time is covered by the focal area, the aligning system comprises for circular and/or rotatable microfluidic discs one part for angular alignment and an optional radial aligning system for recognizing the radial position of the part area which at a particular time is covered by the focal area, and
(c) a controller, e.g., computer with software, which controls
   (i) equipment causing the focal area to transverse a zone containing the detection areas of a microfluidic disc/device, e.g. in an annular zone of a circular and/or rotatable disc, and
   (ii) the detector head successively collects signals in a preselected manner from individual subareas of essentially the same size as the focal area within at least one of the detection areas in said zone.

As shown in FIG. 1, each of said stations is connected to the controller 110 and controlled and monitored from the controller 110 by means of a number of operations. A software operation is defined as a logical group of hardware instructions, which are performed to accomplish a certain function, such as:
Implementing transport of liquid, for instance spinning the device if the device is in the form of a disc that can be spun in order to induce liquid flow.
Sample transfer to a specific common distribution channel or a specific microstructure.
Reagent transfer to a specific common distribution channel or a specific microstructure.
Position the microfluidic device.
Incubate the liquids at a certain position in the microstructures for a specific time.
Detection, i.e. detection of the results of the method carried out in the microfluidic device, or of the presence and/or the absence of a liquid phase and/or a gas phase in one or more pre-selected liquid detection segments as discussed above.

An operation may consist of a number of steps. A step is a non-dividable instruction, such as a ramp in a spin operation. A set can be constituted by putting together a number of these operations in a desired order. Such a set is defined as a method and controls all parts conducted within the instrument. It prescribes a type of microfluidic device and defines a set of actions, operations. It may prescribe halting for conducting steps outside the instrument, for instance incubations at constant temperature when the method concerns cell culturing.

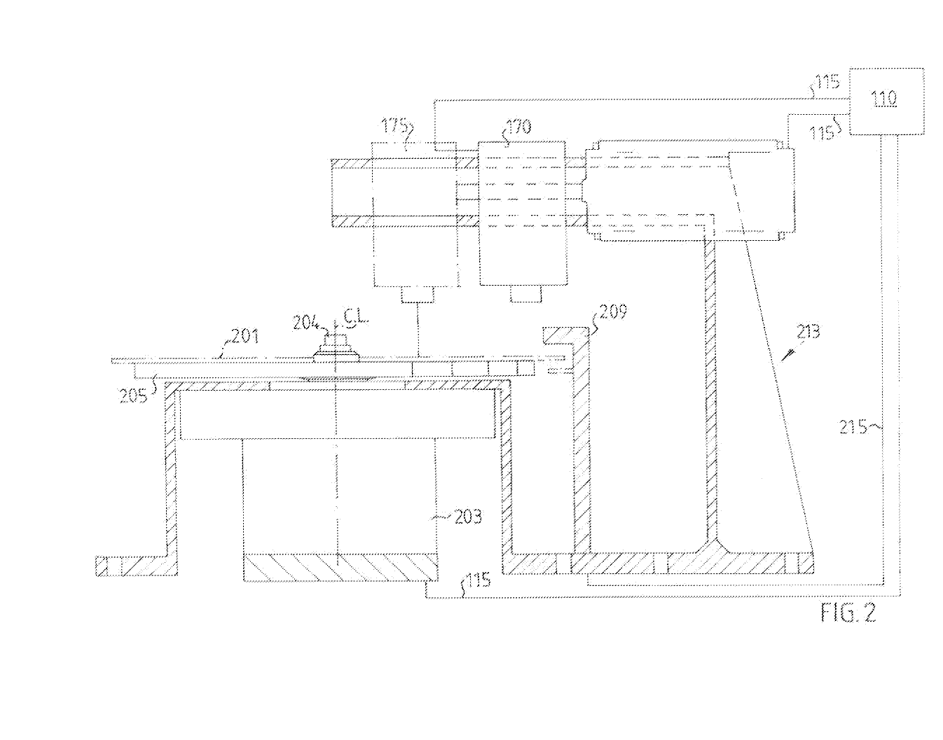

FIG. 2 shows a liquid detector station arranged with a spinner function in a microfluidic system according to the invention (rotatable microfluidic device). In a typical variant, a motor 203 (e.g., a spinner) with a rotatable shaft 204 carrying a disc holder 205 are supported on a frame structure 213. The motor 203 controls the rotating speed that can be varied, e.g., within an interval between 0-15,000 rpm, such as above 60 rpm. The rotation of the disc 201 may be stepwise. The disc holder 205 is preferably a plate on which the disc can be placed. The disc holder could also be a device that holds the disc at its periphery. In preferred variants the disc is retained on the holder by vacuum applied via the side of the plate facing the disc. See for instance US 2003/0082075 (Gyros AB) and US 2003/0064004 (Gyros AB). Depending on the principle used for detecting liquid/gas in a liquid detection segment, the liquid detector station may comprise a sensor unit 175, e.g. a liquid detector head (detection principle based on radiation) or a sensor (not shown) (detection principle based on conductivity etc) physically in direct contact with the liquid detection segment.

In principle any kind of detection principle that is capable of a) discriminating between a liquid phase and a gas phase and/or b) detecting a liquid meniscus in a microchannel can be used. The most attractive way is an image detector device for imaging one or more liquid detection segments of one or more microchannel structures at a time. Other alternatives are by visual inspection possibly combined with magnification of the relevant liquid detection segments of the microchannels structures. The above-mentioned differences can be enhanced by addition of suitable agents such as salts, light absorbing solutes, fluorescent solutes, particles etc with due account taken that the agents used should not disturb the experiment as such or the measurement of the result of the experiment.

In the system described in WO 03/1002559 (Gyros AB) the same principle is used for measuring the result of the experiment from a detection microcavity as used for detecting the presence/absence of liquid and/or gas in a liquid detection segment. The system illustrates the possibility for highly integrating the detector station 170 with the sensor unit 175 of the liquid detector station.

An image detection/registration can be carried out both with detector head devices in a sensor unit that are able to directly generate images in a digital format, starting from the light radiation incident on the detecting elements (digital video cameras, webcams, etc.) and with analog detecting devices in the sensor unit (e.g. television cameras or video cameras), associated with appropriate converters capable of obtaining images in a digital format by processing corresponding images of analogue type. The image detection can be carried out by means of C-MOS devices that, with respect to other technologies, have reduced production costs, the possibility of integrating all functions necessary to the television camera into the same chip, low consumptions, high dynamics and high acquisition velocity. The liquid detector head device should have relatively high resolution.

The liquid detector station is also associated with a controller function that is part of the controller 110 of the system. This controller function may be used for one or more of the following tasks:
1) Controlling the alignment with and/or measurement in a particular microchannel segment at a predetermined stage of an experimental protocol. The predetermined stage may be immediately before, during or after liquid has entered the segment from an upstream lication and/or before, during or after liquid transport has been implemented from the segment.
2) Relating the result of the measurement (presence or absence of a liquid phase/gas phase and/or a liquid meniscus in the segment) to what is expected from the protocol of the experiment.
3) Flagging experiments as low quality experiments if the liquid handling has failed for them. This part of the control function may also include that the result of the experiment concerned is discarded and/or allotted a low confidence.

The system also has to contain a position device (denoted as 209 in FIG. 2) for determining when a predetermined position of the microfluidic device or disc is in front of a needle or a detector objective. Different position devices are known in the market. For rotatable microfluidic devices there are encoders, absolute position encoders etc. A simple but less accurate alternative is to include calculating means that calculates the time needed from a preset rotation speed and the angular distance between the predetermined position and a home position mark (i.e., from the preset rotation speed and the angular position co-ordinate). This kind of calculating means may be associated with the controller. For rectangular non-rotating microfluidic devices conventional X-Y positioning devices can be used.

The use of the above-mentioned kind of positioning devices for dispensing of liquids, detection of radiation from detection areas etc in rotatable microfluidic devices has been utilized in Gyrolab Workstation (Gyros AB, Uppsala Sweden). See for instance US 2003/0094502 (Gyros AB), 2003/0054563 (Gyros AB). Alternative variants utilizing detector heads and dispensing heads with positioning functions combined with labeled detector areas and labeled inlet ports for liquid have been described in U.S. Pat. No. 6,338,820 (Alexion) and WO 96/09548 (University of Glasgow).

An absolute encoder is a position device that progressively gives the angular distance from the home position mark while the disc is rotating.

The position device 209 in FIG. 2 is typically associated with the motor 203, the shaft 204, and the disc holder 205 and connected to a position controlling means of the controller. By associating the position device directly with the disc 201 it is likely that the most accurate determination of positions will be accomplished. This kind of position device typically divides each revolution of the shaft into a large number of grades, denoted as resolution grades, for instance >5 000, such as >10 000 or >20 000 or >30 000. The position device should be able to give the angular position coordinate for the part of the disc which is in front of a home position mark detector with an accuracy and resolution of ±1°, such as within ±0.1° or within ±0.01° (provided there are 360° per revolution). The exact accuracy needed will depend on the size of the disc, radial position of the detection area, the required sensitivity, size of detection area, etc

The position controlling means 220 of the controller 110 will receive or transmit different data using a position signal P over the connection 215 depending on the type of position device 209. If the position device is an encoder generating a pulse for each resolution grade, the position controlling means involves a pulse counter for registering the pulse sum value that is representing the current position of the disc relative to a start position or the home position, and the detector. If the position device is an absolute encoder, the position controlling means will receive or transmit an absolute measure of the angular distance from a start position or the home position. In either case, the position controlling means of the controller is able to control the position device. The position controlling means sets a desired position and transfer the desired value to the position device, which receives the position and controls the motor 203, the shaft 204, and the disc holder 205 to set the disc in the desired position.

What has been said above about the position device of a liquid detector head applies, where appropriate, also to the detector head of the detector station 170, to the liquid transfer station 150 etc.

A method for finding the correct home position mark and determining the accurate home position on the current disc laying on the disc holder is earlier described in WO 03/087779 (Gyros AB). Said process is often denoted as the “homing process”.

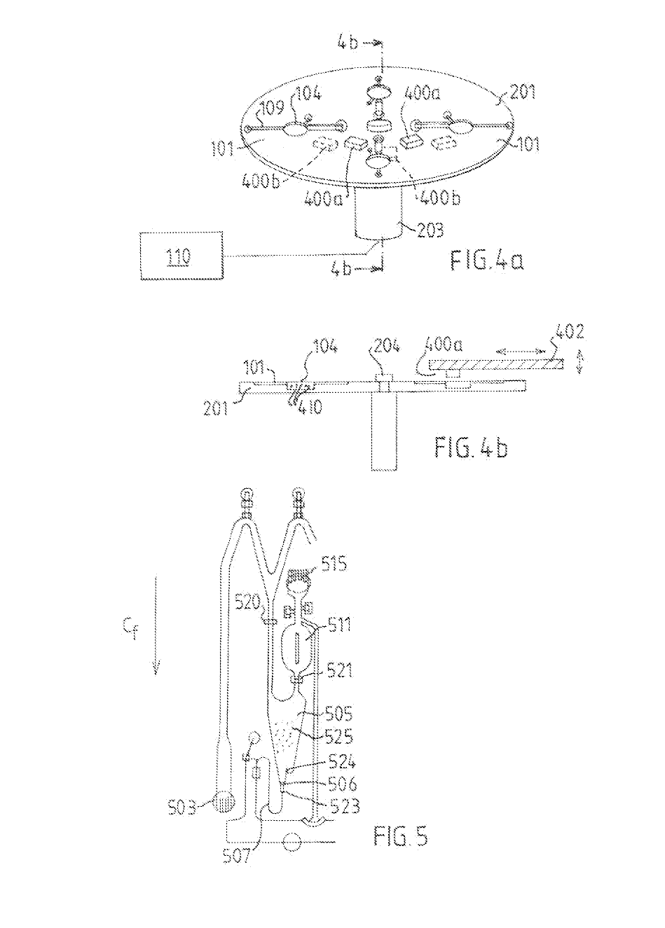

Before describing different microfluidic discs relating to the invention, the invented magnetic arrangement will be described in more detail with reference to FIGS. 4a and 4b. FIG. 4a is a schematic illustration of the arrangement according to the invention. FIG. 4b is a side view of a cross-section along the line 4b-4b of the microfluidic disc attached on a spinner station axel and motor. As described in connection to FIGS. 1 and 2, the spinner station 203 is controlled by the controller 110 that makes it possible for a person to program spinning sequences using rotation speeds from 0 up to very high rotations per minute (rpm), e.g. up to 20000 rpm or up to 30000 rpm, and with an acceleration capacity up to 10000 rpm/second. The arrangement comprises a) a spinner station 203, b) a controller 110, c) one or more magnets that are external to the microchamber in which particle motion is to be controlled, and d) an optional microfluidic device 201.

The microfluidic device disc 201, which with described in connection to FIG. 3, contain microchannel structures 101 with their microchambers 405 located at equal or different radius from the center of the microfluidic device. It is possible to have one or more radii of microchambers and/or microchannel structures.

The magnetic particles 410 of magnetic material, e.g. ferrite, that are present in a microchamber of the microfluidic device are typically introduced dispersed in a liquid into all or at least a number of the microchannel structures, for instance via a common or an individual inlet port as described for the drawings. Alternatively the particles may have been introduced during the manufacturing of the device. The particles used may be in the form of beads and may be monosized or polysized within the meaning of WO 02/75312 (Gyros AB). The mean size of a particular particle preparation used may typically be selected in the interval from 1 nm, such as from 1 μm, up to 200 μm or up to 100 μm or up to 50 μm. The particles may be manufactured from non-magnetic material, e.g. polymeric, into which minor particles of magnetic material, such as ferrite, have been incorporated or they may be based on magnetic particulate material, such as ferrite, that may have been appropriately surface modified. It is convenient that microchannel structure design and the size of the beads/particles are adapted or selected to each other in order to avoid undesired leakage of particles through the outlets of the microchamber.

As illustrated in FIGS. 4a and 4b, a number of magnets 400a, 400b (one or more) are placed in close connection to the spinning plane of the microfluidic disc. Each magnet is typically placed on a mechanical bearer or support 402, e.g. one arm for each individual magnet, or one common holder for magnets above the disc and one holder for magnets placed under the disc, or one common holder for all magnets irrespective of magnet position. Said bearer or supports 402 may be fixedly or removable mounted. In another embodiment, the bearers or supports are connected to a steering device (not shown) that permits the magnets to be manoeuvred horizontally, e.g. radially, in relation to the microfluidic device or spin axis and/or vertically up and down from the spinning plane defined by the microchamber(s). Said steering device is preferably connected to and controlled by the controller. The distance between the magnets and the device can vary e.g. from half a millimetre up to at least 15 millimetres. It is possible to place the magnets either over or under the spinning plane, but it is sometimes favourable to have magnets both over and under the spinning plane. The magnet/magnets is/are preferably placed at the same radius from the centre of the device, i.e. the spin axis, and may be limited to a segment or sector of the microfluidic device. Said bearer or supports are in some variants possible to remove from the disc area making it possible to remove the disc from the disc spinner.

The magnets can be permanent magnets or electromagnets. The controller may be connected to the electromagnets for turning the magnetic field on or off or for controlling the strength of the magnetic field.

The magnets don't need to be equidistantly placed all around the disc as shown by Gruman et al (Ibido). According to the invention, it's enough to position one single or a few magnets, e.g. two or more magnets, that provides a magnetic field that covers at least a single microchamber when radially aligned with the magnet/magnets, for instance covers ≧0.27π radians, or ≧0.4π radians or ≧π radians. One advantage over previously known methods is that it is easier to bring other detector units close to the disc area. Another advantage is that the suggested magnet positioning eliminates or at least reduces magnetic detection disturbances considerably.

One or more of the magnets (first set_{I}) are preferably located at an inner radius in comparison to the particle pocket or microchamber (closer to the spin axis than the particle pocket or microchamber), i.e. the magnets are located between the centre (the spinning axis) of the disc, and the pocket or the microchamber. Thus, the magnet field in this variant is created by a first set_{I} of magnets 400a (one or a plurality) that are placed at radial position(s) that is/are equal to or closer to the spin axis than the radial position of the outermost part of the microchamber, such as equal to or closer to the spin axis than
a) the radial position of the innermost part of the microchamber, or
b) the mean radial position of the radial positions of the outermost part and the innermost part, respectively, of the microchamber.
   In other words the magnets of set_{I} should in most variants be placed at a radial position that is between the spin axis and the pocket or the microchamber, or at a radial position encompassed by the radial positions covered by the microchamber.

Further, one or more magnet(s) including all of the magnets of the first set_{I} are physically separated from the device, spread over a limited radii sector of the disc and are preferably not co-spinning with the disc, such as being at a fixed position outside the device.

The first set_{I} may comprises one, two or more magnets 400. If set_{I}, comprises two or more magnets the set may be divided into two subsets: subset Iₐ with magnets 400a on one side of the device/spin plane and subset I_{b} with magnets 400b on the opposite side of the device/spin plane (above and below the spin plane/microcavity).

In another embodiment, an additional second set_{II} of magnets (one or a plurality) is provided at radial positions that are further away from the spin axis than the outermost magnet of set_{I}, for instance at radial positions larger than radial position of the outermost part of the microchamber(s). Said second set may be removable for eliminating eventually bad influence of the steering of the particles when using the first set_{I} of magnets.

In another embodiment of the invention, one or more of the magnets of set_{I} and/or set_{II} (if present) are attached to the microfluidic device and are thus co-spinning with the device.

The number of magnets used, their magnetic strength (in Tesla), the distance of these magnets to the spin plane defined by the microchamber(s), the material in the microfluidic device etc determine the strength of the magnetic field at a particle microchamber. The closer the magnets are positioned to the disc and the more magnets that are used, the stronger magnetic field is provided and present in the microchamber. These parameters determine also how quickly particles move inwardly, the necessary rotation speed to pull the particles outwardly and the shape of the particle cloud in a liquid.

The shape of the particle cloud is influenced by the magnet positions in relation to the disc. The closer the magnets are positioned to the disc plane the more concentrated particle cloud is obtained, i.e. a denser particle cloud is formed. Hence, a broader cloud is generated by moving the magnets to a larger distance from the disc plane.

According to the present invention, magnetic particles are deviated to the right or the left according to the direction of the spinning (clockwise or counter-clockwise) because said particles pass close to the magnetic field and their displacements are only a function of the position of the magnets placed at the inner radius of the microchannel structures. The spinning of the disc clockwise or counter-clockwise at a disc rotation speed where the magnetic force is lower than the centrifugal force results in a particle movement towards the leading wall of the microchamber.

This arrangement of magnets and spin speed control could be used for a) mixing of homogenous and heterogeneous liquid phases in a particle microchamber, and b) performing heterogeneous reactions between a reactant immobilized to the magnetic particles and a reactant that is in dissolved or in particulate form in a liquid phase placed within a particle microchamber. The present invention is especially useful for controlled movement of magnetic particles into a certain spacing of a particle microchamber, e.g. a particle pocket.

The innovative method comprises three main steps:
(i) providing the microfluidic device of the type described above with magnetic particles in one or more of its particle microchambers;
(ii) providing the magnetic field as described above, and
(iii) performing
   a) moving the particles outwards by spinning the device at a speed that creates a sufficient centrifugal force for outbalancing the magnetic force that tends to pull the particles inwards followed by
   b) moving the particles inwards by spinning the device at a speed that creates a centrifugal force that is outbalanced by the magnetic force that tends to pull the particles inwards.
      Step (iii) comprises that
(A) there may be other steps between substeps (a) and (b),
(B) substep (a) may be performed before or after substep (b), and
(C) the sequence substep (a) followed by substep (b) or the reverse may be repeated a predetermined number of times, possibly interrupted or followed by other steps as discussed below.

The first time substep (a) is performed, it typically starts with the particles provided in a pocketₐ of the particle microchamber. The last time substep (b) is performed it typically ends with placing the particles in a pocket_{b} of the same microchamber as used in the initial substep (a). Pocketₐ may be the same as or separate from pocket_{b}. In other words the microchamber may contain one, two or more particle pockets as described in the context of the drawings. Intermediary substeps (a) and (b) may or may not start/end with the particles in a pocket that may be the same as or different and/or physically separated from the pocket utilized in an initial substep (a) or in an ending substep (b).

Magnetic particles provided in a pocket may be in sedimented or suspended form. A sediment through which liquid can pass is called a column or a porous bed of packed particles.

By placing the magnets as described above and spinning at the appropriate spin speed it is possible to force the particles to deviate from a straight radial movement within the microchamber. During spinning the particle movement thus will contain a radial component and an angular/circumferential component. The latter will be towards a leading inner side/wall of the microchamber, which means that a change in spin direction will reverse the angular/circumferential component in particle movement. Clockwise spinning will lead to movement of the particles in a positive angular direction and counter-clockwise spinning in a negative angular direction. If the spinning/centrifugal force is sufficiently high the tendency to link the particles towards a leading inner side/wall will be negligible and if the spinning/centrifugal force is sufficiently low, primarily low enough for the particles to move inwards the spin axis, then the link of the movement towards the leading inner side will be significant. Thus by the proper spin program it can easily be arranged so that the particles will traverse the whole liquid volume placed in a microchamber and/or will move to any arbitrary part of the microchamber in which there is a liquid. Particles that have reached the part of an inner wall that is associated with a particle pocket can easily be forced to sediment into the pocket by increasing the centrifugal force/spin speed to outbalance the magnetic force.

Two basic inventive patterns of particle movements are: A) Up-and-Down, and B) Angular Back-and-Forth (also called Zig-Zag). In the next paragraphs these basic patterns will be illustrated starting with magnetic particles that are in sedimented form in a particle pocket and with one or more magnets positioned as described for set_{I} above.

The Up-and-Down pattern has as the main purpose to move particles into a particle pocket where they are collected in suspended or sedimented form. Starting the movement with particles that are present as a sediment in a particle pocket, the initial spin speed is set sufficiently low for depacking and formation of a particle cloud that typically will move towards the spin axis along the leading inner side/wall of the microchamber to a desired level above the pocket. The desired level is typically the upper meniscus, if present, or the inner upper wall of the microchamber (provided the liquid phase is in contact with this wall) (upper is relative to the spin axis). There are two main alternatives for the subsequent step(s): a) maintaining the spin direction while increasing the spin speed to overcome the magnetic force, or b) reversing the spin direction and setting the spin speed (i) sufficiently low for the particle cloud to move with an angular component towards the inner wall that now is leading (opposite to the leading inner wall during the depacking), or (ii) sufficiently high for outbalancing the magnetic force. Alternative (a) will typically lead to collection of particles in a particle pocket associated with the same inner wall along which the particles moved during the depacking, e.g. the pocket from which the particle started or a pocket located at a shorter radial distance than the starting pocket. Alternative (b.i) comprises spin speed(s)/step(s) that move the particle cloud outwards or towards the spin axis and include spin speed(s) and spin time(s) that will allow the particle cloud to reach the leading inner wall (that is opposite to the inner wall along which the cloud was transported during depacking). For sufficiently high spin speeds the magnetic force will be outbalanced and the particles moved outwards from the spin axis and placed in a pocket associated with this wall. Depending on the design of the microchamber this latter pocket may be the same as the pocket from which depacking occurred or a separate pocket closer to the spin axis.

The angular Back-and Forth pattern may similarly to the Up-and-Down pattern start at a sufficiently low spin speed for moving the particles in the form of a particle cloud inwards with an angular component towards or along an inner side/wall of the microchamber. The start may be from a particle pocket in which the particles are present as sediment of the same kind as in the preceding paragraph. The spin direction is then repeatedly reversed two or more times (clockwise to counter-clockwise or reverse depending on the starting direction), i.e. repeatedly changing the direction of the angular component in the particle movement, preferably while allowing the particle cloud to reach the leading inner wall/side before a reversal. The repetitive part may comprise one or more repetitions for which the spin speed is progressively increased or decreased without causing sedimentation of the particles. Finally the spin speed may be increased to move the particle cloud outwards away from the spin axis, for instance into a pocket where the particles may be collected as a suspension or a sediment. If this pocket is designed for outlet of particles, then the magnetic particles may be forced out of the microchamber via such an outlet.

The innovative method may be used in various kinds of experiments in which there is one step comprising a reaction between a reactant R₁ that is immobilized to particles and a reactant R₂ that is in dissolved form in a liquid where R₁ and R₂ are said to be reactive counterparts to each other. Dissolved in this context includes that reactant R₂ is a true solute or is in suspended form. The reaction may be an affinity reaction between two affinity counterparts R₁ and R₂ for formation of an affinity complex that may be a) transiently formed such as in a catalytic reaction like an enzyme reaction, b) further processed such as in various kinds of receptor-ligand affinity assays like nucleic acid assays and immune assays, c) between a cell adhering ligand (R₁) and cells (R₂) for instance for culturing the cells in suspended form adhering to the magnetic particles, d) chemical reactions for chemically transforming R₁ to another group including covalent immobilization of R₂ to the magnetic particles etc. The experiment may thus be part of an analytical assay for determining an analyte in a liquid sample, solid phase synthesis, isolation of a solute (R₂) from a liquid etc. The term “determining” in analytical assays includes identification and/or quantification and other aspects of characterization of an analyte. Typically analytical assays are receptor-ligand or affinity based assays including enzyme assays, nucleic acid assays involving a hybridisation step, immune assays etc. The assays may be competitive or non-competitive. Important examples of the latter are sandwich assays.

R₁ and R₂ may thus be selected among a) components of a catalytic system, such as a biocatalytic system like an enzyme system, b) members of a receptor-ligand pair such as antigen/hapten and antibody, cell surface structures and soluble or dissolved substances that are capable of interacting with the structures, etc, c) complementary nucleic acids.

The liquid phase in which the particles are to be moved may be in the nl-range, i.e. ≦5000 nl, or larger such as in the range in the range of 0.5 μl-1000 μl, such as 1-1000 μl or 1 μl-100 μl or 1 μl-50 μl or 1 μl-10 μl. Volumes above the nl-range are most typical in the case the liquid phase derives from an original biological sample from which a reactant R₂ in low concentration, such as ≦10⁻⁶ M or ≦10⁻⁹ M, is to be captured by the particles. Processing of the magnetic particles after being placed in a pocket typically requires smaller volumes of liquids that in individual steps may be in the nl-range such as ≦1000 nl or ≦500 nl or ≦250 nl. This liquid is typically is leaving the pocket through a liquid outlet associated with and/or physically separated from said pocket. The ratio between the liquid phase in step (iii) and a second liquid used in subsequent processing may be ≧0.001, such as ≧0.01 or ≧0.1 or ≧1 or ≧10 or ≧100, and/or ≦100, such as ≦10 or ≦1 or ≦0.1 or ≦001 or ≦0.0001. In particular for liquid phases from which an entity is to be captured/concentrated in step (iii) this ratio may be ≦1 or ≦0.1 or ≦001 or ≦0.0001.

Microfluidic Devices or Discs Including Illustrative Examples of Microchannel Structures Containing Particle Microchambers

FIG. 3 shows a subset of 8 microchannel structures of a microfluidic device that can be used according to the invention. In total the device contains 96 structures. Microfluidic devices that can be used according to the invention typically comprises one or a plurality of microchannel structures (microlabs) in which aliquots (=droplets) of liquids are transported and/or processed. Plurality in this context means ≧5, such as ≧25 or ≧50 or ≧100 microchannel structures per device. The upper limit may be 200, such as 400 or 1000 microchannel structures per device.

The devices typically are disc-shaped with the microchannel structures oriented in one or more planes. The structures are enclosed in the sense that their interior is in contact with ambient atmosphere via separate inlet and/or outlet openings and/or vents.

The microchannel structures have microscale dimension by which is meant that their chambers and/or channels and/or other microconduits have at least one cross sectional dimension that is in the range from about 0.1 μm, such as from 1 μm or from 10 μm, to about 1000 μm such as to about 500 μm (depth and/or width). The liquid volumes (aliquots) that are processed in the μl-range are transported and processed within the network. The μl-range encompasses volumes <1000 μl, such as ≦100 μl or ≦20 μl or ≦10 μl and includes the nl-range as well as the picolitre range. The nl-range encompasses ≦5000 nl, such as ≦1000 nl or ≦500 nl or ≦200 nl. Volumes in the μl-range are also applicable for the various microcavities or microchambers of the network or of individual microchannel structures, for instance the particle microcavity.

FIG. 3 shows a subset of 8 microchannel structures of a microfluidic device that can be used according to the invention. In total this device contains 96 structures.

A microchannel structure (each of 301a-h) of a microfluidic device 300 comprises in the downstream direction (for microchannel structure 301a):

a) an inlet function (302+303a+303b+304a),

b) a microchamber (305a) in which the particles are moved,

c) a particle pocket (306a) to which the particles are guided/collected, and

d) an outlet function (307a+308a+309).

The particle pocket (306a) is typically formed in a part of the microcavity 305a that is locally more remote from the spin axis than the most neighbouring other parts of the microcavity. The particle pocket (305a) is equipped with an outlet for liquid that do not allow passage of particles.

The inlet function (302+303a+303b+304a) is needed for the introduction of liquid into the microchannel structure (e.g. 301a). The inlet function primarily comprises one or more physically separated inlet arrangements (IA), each of which contains at least one inlet port (303a-b;315a), and typically also one or more volume-defining units (302; each of 310a-h) which comprises (for structure 301a):
i) at least one volume-metering microcavity (311a,312a),
ii) at least one inlet microconduit (313a-b,314a) that in the upstream direction is communicating with an inlet port (303a-b,315a) and in the downstream direction with a the volume-metering microcavity (311a,312a),
iii) an outlet microconduit (316a,317a) connected to the outlet end of the volume-metering microcavity (311a,312a), and
iv) typically also a microconduit (303a-b,318a) for draining excess liquid to a waste function (overflow microconduit=excess microconduit).

FIG. 3 illustrates two kinds of inlet arrangements (IAs). The first kind (for structure 301 equal to 304a) communicates in the downstream direction with only one microchannel structure (301a) and in the upstream direction with only one inlet port (315a) and typically comprises a volume-defining unit (310a) that has the subunits i) volume-metering microcavity (311a), ii) inlet microconduit (314a), iii) outlet microconduit (317a), and -iv) overflow microconduit (318a). The second kind (302) is common to several microchannel structures (301a-h) and typically comprises a volume-defining unit (302) with two or more volume-metering microcavities (312a-h) which each has an outlet microconduit (316a-h) which in the downstream direction is communicating with a microchannel structure (301a-h) and in the upstream direction with one, two or more inlet microconduits (313a-b) that are common to all of the volume-metering microcavities (312a-h). As illustrated in FIG. 3, an inlet microconduit (313a-b) of this kind of volume-defining unit may have a dual function in the sense that it also can function as an overflow microconduit for at least two volume-metering microcavities (312a-h) (=overflow microcondits for the volume-defining unit (302)). A volume-defining unit (302) that is common to several microchannel structures (301a-h) is also called a distribution manifold.

A microchamber (305a) in which particles are to be moved may contain one, two or more particle pockets (306a), each of which in a typical case is formed in a part of the microchamber (305a) that is more remote from the spin axis than the most neighbouring other parts of the microcavity. A particle pocket may have an outlet that permits outlet of both particles and liquid or selective outlet of only liquid as illustrated for pockets (306a-h and 506) FIGS. 3 and 5. Alternatively a pocket may contain no liquid outlet as illustrated for pocket (524) in FIG. 5. A particle pocket permitting only outlet of liquid is typically accomplished if an outlet has a cross-sectional dimension that prohibits outlet of particles but not of liquid, for instance in the form of a dual depth (323a) (decreasing depth in the downstream direction). A particle pocket for outlet of both particles and liquid may be accomplished if a downstream part of the microchamber in which particles are to be moved and the upstream part of the outlet microconduit from the microchamber defines a U-shaped microconduit with the lower part of the U being directed outwards from the spin axis. The cross-sectional dimension of the outlet shall be selected to permit passage of liquid as well as of particles.

A microchannel structure that is intended for carrying out a process protocol that comprises reactions between various reactants typically comprises a reaction zone that typically comprises one or more reaction microcavities each of which is intended for a separate step of the protocol. The reaction zone may also comprise additional functional units, e.g. between two reaction microcavities. Typical such functional units are volume-defining units, mixing units, separation units for removing contaminating material such as undesired particles or undesired soluble material, detection units in which the result of the process protocol/experiment or of a part step thereof is measured, etc. In some variants this kind of functional units may have a combined function, e.g. by containing a microcavity in which one or more reactions of the intended protocol are to be performed. The reactions contemplated are typically chemical, biochemical and/or biological.

The microchamber (305a-h), in which the magnetic particles are moved, or the particle pocket as such may function as a reaction microcavity.

The outlet function of a microchannel structure (301a) typically comprises one or more outlet arrangement (OA) which each contains at least one outlet port (319a) that vents out over-pressure created during liquid transport to ambient atmosphere. In many cases an outlet port also functions as an outlet for liquid that has passed through the structure. An outlet arrangement typically also contains an outlet microconduit (307a) from the most downstream microcavity, e.g. microchamber (305a) in microchannel structure (301a) of FIG. 3, and possibly also a waste function comprising the outlet port (319a), a waste microconduit (308a) and/or a waste chamber/channel (309) etc. As illustrated in FIG. 3, the outlet arrangement (OA) may or may not comprise parts that are common (309,319a-h) to several microchannel structures (301a-h) or only belongs (313a307a,315a308a) to one such structure (301a).

Within a microchannel structure the transport of a liquid aliquot may be halted at valves that may be closing or non-closing. The terms “non-closing” and “closing” valves have been defined in WO 02/074438 (Gyros AB). Valve functions in microchannel structures are typically associated with an outlet of a microcavity, a microconduit and the like. In FIG. 3, valves (320a-h,321a-h,322a-h) are indicated at the outlet of each volume-metering microcavity (312a-h,311a-h) and at the outlet of each overflow microconduit (318a-h). Valves may also be present within and or at the inlet or outlets of microconduits of other kinds and/or at the outlets of other kinds of microcavities, for instance so called retaining microcavities including mixing microcavities, detection microcavities, reaction microcavities, collecting microcavities, premixing microcavities, liquid storing microcavities etc.

Further details about the fluidics of the structures presented herein and the various functional units described are given in WO 02/075775, WO 02/074438, WO 02/075312, WO 03/018198, WO 03/025498, WO 2005/094976, WO 2005/032999, US 2005/0141344, WO 2004/103891, and US 2005/0042770 (all of Gyros AB) etc. all of which are incorporated by reference in their entirety.

Microconduits, microcavities, inlet port, outlet ports, distribution manifolds, waste microconduits etc that are common to several microchannel structures are part of all the microchannel structures they are common for.

FIGS. 5-7 illustrate other designs of a microchannel structures that have a microchamber with a pocket and which can be used in the innovative method.

The use of the innovative method in the microchannel structures (301a-h) of FIG. 3 will now be detailed as a part of a non-competitive receptor ligand assay such as a sandwich assay. Each microchamber (305a-h) has a triangular shape and a pocket (306a-h).

Step 1: Packing a porous bed using magnetic particles coated with a capturing antibody (R₁) that is specific for an analyte (R₂). The particles are typically introduced via the common inlet port (303a-b) whereafter the device is spun at a sufficiently high speed to force the beads to form a porous bed (column) in the particle pockets (306a-h). Spin sequence/method B below is preferably used.

Step 2: Washing the column (spin flow)—quick spin. A wash liquid is typically introduced via the common inlet port (303a-b) followed by quick spin that forces the liquid through the porous bed without depacking.

Step 3: Capturing the analyte to the magnetic particles by using the Zig-Zag method. The liquid sample that contains the analyte is preferably introduced via a common inlet port (303a-b) if the assay is to be carried out as a paralleled multiplicate and via the individual inlet ports (315a-h) if different samples are to be assayed in parallel. The liquid is transported to the microchambers (305a-h) and collected on top of the porous bed by spinning at a spin speed that keep the particles in the pockets (306a-h). Thereafter the Zig-Zag method is initiated to allow for efficient capturing. The Zig-Zag-method is ended by an increase in spin speed to repack the particles as porous beds in the pockets (306a-h) while the liquid exit the chambers through the outlet microconduits (307a-h).

Step 4: Washing the column (spin flow) a few time—quick spin

Step 5: Addition of a detecting antibody (fluorophore conjugate to an antibody) by introduction of a liquid sample containing this antibody and using a Zig-Zag method in the similar manner as for capturing of the analyte in step 3.

Step 6: Wash the column (spin flow) a few times—quick spin—in the same manner as in step 2.

Step 7: Detect fluorescence from the porous bed in pockets (306a-h).

For the structure/microchamber of FIG. 3, an optimal Up-and-Down spin sequence is:

| Spin rpm | Acc. rpm/sec | Plato sec |
|---|---|---|
| +1000 | 8000 | 3 |
| 0 | 8000 | 0.1 |
| −100 | 8000 | 2 |
| −50 | 8000 | 1 |
| +50 | 8000 | 1 |
| +100 | 8000 | 2 |
| 1000 | 8000 | 2 |
| 0 | 8000 | 0.1 |
| +100 | 8000 | 2 |
| +50 | 8000 | 1 |
| −50 | 8000 | 1 |
| −100 | 8000 | 2 |
| −1000 | 8000 | 2 |
| 0 | 8000 | 0.1 |

For the structure/microchamber of FIG. 3, an optimal Zig-Zag spin sequence is:

| Spin rpm | Acceleration rpm/sec | Plato sec |
|---|---|---|
| 1000 | 8000 | 3 |
| 0 | 8000 | 0.2 |
| −600 | 8000 | 1 |
| 0 | 8000 | 0.2 |
| 600 | 8000 | 1 |
| 0 | 8000 | 0.2 |
| −500 | 8000 | 1 |
| 0 | 8000 | 0.2 |
| 500 | 8000 | 1 |
| 0 | 8000 | 0.2 |
| −400 | 8000 | 1 |
| 0 | 8000 | 0.2 |
| 400 | 8000 | 1 |
| 0 | 8000 | 0.2 |
| −300 | 8000 | 1 |
| 0 | 8000 | 0.2 |
| 300 | 8000 | 1 |
| 0 | 8000 | 0.2 |
| −200 | 8000 | 0.1 |
| 0 | 8000 | 0.2 |
| 200 | 8000 | 1 |
| 0 | 8000 | 0.2 |
| −300 | 8000 | |
| 0 | 8000 | 0.2 |
| 300 | 8000 | 1 |
| 0 | 8000 | 0.2 |
| −400 | 8000 | 1 |
| 0 | 8000 | 0.2 |
| 400 | 8000 | 1 |
| 0 | 8000 | 0.2 |
| −500 | 8000 | 1 |
| 0 | 8000 | 0.2 |
| 500 | 8000 | 1 |
| 0 | 8000 | 0.2 |
| −600 | 8000 | 1 |
| 0 | 8000 | 0.2 |
| 600 | 8000 | 1 |
| 0 | 8000 | 0.2 |
| 1000 | 8000 | 3 |

FIG. 5 illustrates an embodiment of a microchannel structure 501, an individual microlab, according to the invention. Said microchannel structure is one of a subset of similar microchannel structures. Such a subset of microchannel structures has already been described in FIG. 3.

Most of the parts of said microchannel structures are the same, and for a more detailed presentation of the microchannel structure of FIG. 5 reference is made to the description of FIG. 3.

According to the presented embodiment of the invention, a particle microchamber is provided before the outlet function 507a of the microlab 501a. In the microchamber 505a, the intimate mixing of different liquids and/or reactants is accomplished by means of the magnetic particles 525. The pocket 524 in this variant is located closer to the spin axis than the connection between the outlet microconduit 507 and microchamber 505. The outlet of microchamber 505 may comprise a valve function, preferably of non-closing type such as a capillary valve function, and does not necessarily be designed as a pocket for instance with a trap function in the form of a dual depth 323 as in the variant shown in FIG. 3. A reaction between liquids and/or reactants may depending on the experimental protocol occur anywhere in the microchamber 505 before the outlet microconduit 307, e.g. within the bulk volume of the chamber and/or in pocket 524 and/or in the outlet part 506 of microchamber 505 if designed as a particle pocket in which the particles can form a porous bed. If the magnetic particles are disturbing the detection and the bulk part of the microchamber is used as detection microcavity, it is an advantage that said particles are removed from the bulk part of the microchamber during a detection step. By means of the suggested magnet configuration, it is possible to drag the particles inwardly and away from the outlet during a slow disc spinning in a certain direction depending on which side of the mixing chamber the pocket is situated. As described above, the particles will follow a trajectory and gather at a leading side wall, which one will depend on the spinning direction. By increasing the spinning speed, the centrifugal force will increase, and the particles will be forced down in the pocket/trap and packed therein. Hence, the invented particle moving method may comprise a step in which the beads after the sequence or as a part of the repetition of the sequence are guided to and as a consequence of a final substep (a) is collected in a bead trap that is a part of or in direct fluid communication with the microchamber.

In the described embodiment of FIG. 5, the microchamber 505 comprises a liquid outlet 507 that is separated from pocket 524. In another embodiment of this microchannel structure, the liquid outlet 507 may be associated with a pocket at the outlet part 506 for instance by placing a dual depth or the like for hindering passage of particles at the border between this part 506 and the outlet 507 of the microchamber 505.

The illustrated embodiment in FIG. 5 may be especially useful when the particles carries an immobilized capturing antibody R₁ and a liquid phase in which the particles are to be moved contains a dissolved reactant R₂ which reactants are reactive with each other (reactive counterparts to each other). The structure of FIG. 5, in particular with outlet part 506 designed as an additional particle pocket, is also adapted for taking care of problems with liquids that contain material that would clog a porous bed of particles to which a dissolved substance has been captured or otherwise reacted. By moving the particles after reaction with the dissolved substance to pocket 524 the liquid containing the clogging material can easily and with a minimized risk for clogging be passed out through outlet microconduit 507 by increasing the spinning.

The use of the innovative method in the structure of FIG. 5 will now be described as part of the same kind of assay as used for FIG. 3. Microchamber 505 has a triangular shape and is designed with two pockets 506 and 524.

Step 1: Packing of a porous bed of magnetic particles carrying a firmly attached capturing reactant is the same as for FIG. 3;

Step 2: Wash the particles in the microchamber (spin flow)—quick spin. In principle the same as for FIG. 3 (step 2);

Step 3: Introduction of sample(s) containing a dissolved substance and capturing is in principle the same as for FIG. 3 (step 3). The preferred Zig-Zag method is given as Spin method B below which ends with a quick and fast spin period during which the particles are packed in pocket 524 and the liquid together with any clogging material that my be present is passing out through outlet microconduit 507a;

Step 4: A wash solution is introduced in the same manner as for FIG. 3. By applying spin sequence/method C below the particles can be packed back into pocket 506. The liquid can then be forced out through outlet microconduit 507 by a quick spin;

Step 5: Washing the microchamber (spin flow) a few times—quick spin. In principle the same as for FIG. 3 (step 4);

Step 6: Addition of detecting antibody, for instance fluorophor-labelled. The introduction of the antibody into the structure can take place in the same manner as for FIG. 3. Capturing of this antibody to the particle is preferably performed by conventionally spinning the liquid antibody sample through the porous bed without depacking;

Step 7: Washing the microchamber (spin flow) a few times—quick spin. In principle the same as for FIG. 3 (step 6);

Step 8: Detecting the result by measuring the amount of detecting antibody that has bound to the porous bed in pocket 506.

The above-mentioned spinning methods for FIG. 5 will now be discussed:

Up-and-Down methods: Each such method typically consists of decreasing quickly disc rotation speed, changing the direction of the disc rotation then quickly increasing the disc rotation. This can be performed by starting in either direction and then change spinning direction to the other. In this way, beads, or particles, are first travelling quickly to the upper meniscus of the liquid along one side of the structure, then passing to the other side, and thereafter travelling quickly downwards. An example of an up and down spinning sequence to manoeuvre particles to follow a trajectory along the column inner walls of a microchamber 505 and the upper meniscus of the fluid may comprise following steps:

| | | |
|---|---|---|
| Spin rpm | Acc. rpm/sec | Plato sec |

Spin method/sequence A Up&Down

i) volume definition of the particles into pocket 506a

| | | |
|---|---|---|
| +1000 | 8000 | 1 |
| +3000 | 8000 | 3 |

(ii) bring particles up to the left corner or left end of the
microchamber 505a or of the upper meniscus

| | | |
|---|---|---|
| +50 | 8000 | 1 |
| +50 | 8000 | 10 |

iii) slowly spin down particles along the left inner wall of
chamber 505a to pocket 506a

| | | |
|---|---|---|
| +1000 | 8000 | 10 |
| +3000 | 8000 | 3 |
| +6000 | 8000 | 3 |

iv) remove the magnetic field, the porous bed is packed

| | | |
|---|---|---|
| +6000 | 8000 | 3 |
| 0 | 8000 | 0.1 |

Spin method/sequence C Up&Down
i) bring particles up to the right corner of the microchamber 505a
or to the left end of the upper meniscus

| | | |
|---|---|---|
| +1000 | 8000 | 3 |
| 0 | 8000 | 0.1 |
| −100 | 8000 | 2 |
| −50 | 8000 | 10 |

(ii) bring particles to the left corner of the microchamber 505a
or to the left end of the upper meniscus

| | | |
|---|---|---|
| +50 | 8000 | 1 |
| +50 | 8000 | 10 |

iii) slowly spin down particles along the left inner wall of
chamber 505a to pocket 506a

| | | |
|---|---|---|
| +1000 | 8000 | 10 |
| +3000 | 8000 | 3 |
| +6000 | 8000 | 3 |

iv) remove the magnetic field, the porous bed is packed

| | | |
|---|---|---|
| +6000 | 8000 | 3 |

Zig-Zag” method: This method consists of in a first step progressively decreasing the disc rotation speed in the same time that the spinning direction is changed. In this way particles are first going upward (towards the inner radius) and then downward (towards the outer radius) by travelling from one side of the structure to another (right-left) according to a zig-zag trajectory.

Spin Method/Sequence B

| | | |
|---|---|---|
| Spin rpm | Acceleration rpm/sec | Plato sec |

i) Zig-Zag pattern can be repeated X times

| | | |
|---|---|---|
| 3000 | 8000 | 3 |
| 0 | 8000 | 0.2 |
| −600 | 8000 | 1 |
| 0 | 8000 | 0.2 |
| 600 | 8000 | 1 |
| 0 | 8000 | 0.2 |
| −500 | 8000 | 1 |
| 0 | 8000 | 0.2 |
| 500 | 8000 | 1 |
| 0 | 8000 | 0.2 |
| −400 | 8000 | 1 |
| 0 | 8000 | 0.2 |
| 400 | 8000 | 1 |
| 0 | 8000 | 0.2 |
| −300 | 8000 | 1 |
| 0 | 8000 | 0.2 |
| 300 | 8000 | 1 |
| 0 | 8000 | 0.2 |
| −200 | 8000 | 0.1 |
| 0 | 8000 | 0.2 |
| 200 | 8000 | 1 |
| 0 | 8000 | 0.2 |
| −300 | 8000 | |
| 0 | 8000 | 0.2 |
| 300 | 8000 | 1 |
| 0 | 8000 | 0.2 |
| −400 | 8000 | 1 |
| 0 | 8000 | 0.2 |
| 400 | 8000 | 1 |
| 0 | 8000 | 0.2 |
| −500 | 8000 | 1 |
| 0 | 8000 | 0.2 |
| 500 | 8000 | 1 |
| 0 | 8000 | 0.2 |
| −600 | 8000 | 1 |
| 0 | 8000 | 0.2 |
| 600 | 8000 | 1 |
| 0 | 8000 | 0.2 |
| 3000 | 8000 | 3 |

ii) bring particles up on the right corner of the chamber
using magnetic stirrin

| | | |
|---|---|---|
| −50 | 8000 | 1 |
| −50 | 8000 | 10 |

iii) slowly spin down particles along the left inner wall of the
chamber 505a to the pocket 506a

| | | |
|---|---|---|
| −1000 | 100 | 10 |
| −3000 | 80000 | 3 |

iv) remove the magnetic field, the bed is packed

| | | |
|---|---|---|
| −6000 | 8000 | 3 |

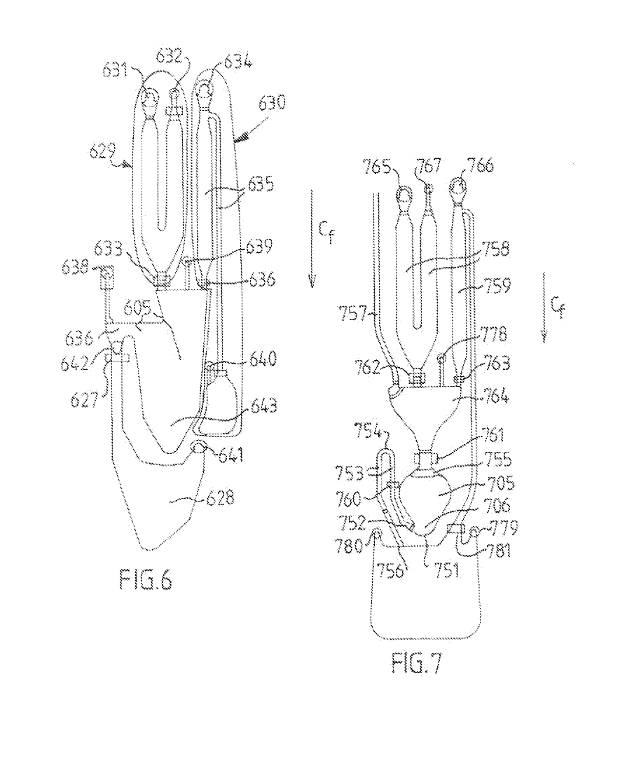

FIG. 6 illustrates a microchannel structure, which allows selective displacement of magnetic particles from a larger microchamber 605 to a smaller microstructure or microcavity 628. This kind of structures represents an interesting issue in microfluidics, i.e. how to interface the macro-world with the micro-world. In some cases a large amount of sample has to be used in order to obtain good detection sensitivity (e.g. >1 μl, such as >10 μl, or >50 μl or more of a liquid sample containing an analyte, upper limit typically <1000 μl). Unfortunately this volume range is not adapted to the conventional size of microstructures (loss of the advantages of miniaturization). Magnetic-stirring of particles according to the invention can give a solution: Interaction, for instance capturing, of the analyte (R₂) with a reactive counterpart (R₁) to analyte that is pre-immobilized to magnetic particles could take place in a large microchamber 605 having a pocket 626 that has
a) a volume that is significantly smaller than the total volume (bulk) of the microchamber 605 and
b) a lower end 642 that is closer to the spin axis than the lowest end 643 of the microchamber (which end is outside the pocket).

As described for FIG. 5, magnetic particles can be selectively guided into pocket 605 and transported downstream to microcavity 628 by application of the inventive method. If the pocket has an outlet with a valve function 627, the particles and liquid collected in the pocket could then be released into a lower microcavity or whatever kind of microstructure is placed downstream of pocket 606. Characteristics that are associated with the particles as a consequence of the interaction between reactants R₁ and R₂ may then be measured or the particles further processed in microstructure 628. Release of the particles from pocket 606 is simply caused by increasing the spin speed if valve 627 is non-closing, such as a capillary valve. Closing valves must typically be actively opened. Only a small fraction of the original sample will thus enter the lower microstructure 628 while the rest of the liquid volume will be waste compared to the particles and remain in microchamber 605 where it can be processed and/or transported further downstream in a microstructure (not shown) that is separate from microstructure 628 that is linked to pocket 626. A product formed by interaction of a reactant R₂ that is present in the liquid with a reactant R₁ that is firmly attached to the particles will be concentrated to the particles if the product also is attached to particles that are contained in the small liquid volume placed in pocket 606. This is typically called capturing and comprises formation of an i) immobilized affinity complex that contains both R₁ and R₂, ii) products of enzymatic reactions where one of the enzymatic components is reactant R₁ and the product is insoluble or otherwise immobilized to the particles, etc.

The liquid volume passing through outlet 642 of pocket 606 typically constitutes ≦50%, such as ≦10% or ≦5%≦1% of the total volume of liquid present in microchamber 605 during the controlled movement of the particles into the pocket. The volume of pocket 642 relative to the total volume of liquid in microchamber 605 is typically less than the corresponding relative liquid volume passing out through outlet 642. These ranges also apply to other pockets with the same functionality.

For structures 628 that contains a nanoliter porous bed at an outlet (not shown in drawing), the way of handling large volumes of analyte samples presented above will minimize column clogging (explained above) and avoid long spin flow times that inherently are necessary to get large volume of sample through the a nanoliter volume porous bed (not shown in drawing) placed at an outlet of microchamber 605. The result most likely will mean a reduction of assay time and improvements in assay performance, such as reliability.

A typical spin sequence for structures of the type illustrated by FIG. 6 is:

| Spin rpm | Acc. rpm/sec | Time sec |
|---|---|---|
| 1500 | 8000 | 3.0 |
| 200 | 8000 | 10.0 |
| 0 | 8000 | 0.1 |
| −200 | 8000 | 5.0 |
| −600 | 8000 | 1.0 |
| −200 | 8000 | 5.0 |
| −600 | 8000 | 1.0 |
| −200 | 8000 | 5.0 |
| −1500 | 200 | 7.0 |

The microchannel structure of FIG. 6, has two kinds of inlet arrangements 629 and 630. Inlet arrangement 629 is intended for analyte samples that are relatively large, for instance ≧0.5 μl, such as ≧1 μl or larger as generally described above, and comprises no volume-defining unit since large volumes often can be dispensed to microfluidic devices/structures with sufficient accuracy. The inlet arrangement 629 has at least one inlet port 631, at least one vent 632 that is at the same level as or closer to the spin axis than inlet port 631, and a valve 633 between the inlet arrangement and the microchamber 605. The other inlet arrangement 630 comprises an inlet port 634, a volume-defining unit 635 of the same general kind as described for FIG. 3 with a valve 636 at the outlet of the unit, i.e. between the unit and microchamber 605.

The valves 627, 633, 636, and 637 in this structure and elsewhere in the specification are preferably non-closing, such as various kinds of capillary valves, for instance based on abrupt local changes in surface characteristics, such as non-wetteable local areas in otherwise wettable inner surfaces of one, two or more inner walls or abrupt changes in one, two or more inner cross-sectional dimensions. Vents to ambient atmosphere are positioned at 632, 638, 639, 640 and 641 and assist in smooth filling of the structures with minimized risk for creation of bubbles. Liquid inlets and liquid outlets, and non-closing valves will also have a vent function in this structure as well as in other structures.

FIG. 7 discloses a microchamber 705 in which magnetic particles can be subjected to controlled movement according to the invention and collected in a pocket 706 defined between the level of a lower extreme 751 of microchamber 705 and the level of a liquid outlet 752 in the lower part of the same microchamber. To liquid outlet 752 there is connected an outlet microconduit 753 that preferably is directed upwards, at least next to the liquid outlet 752. This outlet microconduit 753 may have an upper extreme 754 that is at a level that is above, below or at the same level as the upper surface 755 of a liquid that is to be present in microchamber 705. The outlet end 756 of outlet microconduit 753 is typically below the level of the lowest end 751 of microchamber 705.

Microchamber 705 is in the upstream direction in fluid communication with one or more inlet arrangements 757, 758, 759 for microchamber 705, for instance via a pre-collecting microcavity 764. One inlet arrangement (indicated as microconduit 757) may provide a liquid aliquot that has been obtained by upstream processing of an original sample within the structure. Another inlet arrangement 758 may be for the introduction of liquid into the structure without metering the aliquot within the device. This in particular applies to larger volumes that can be introduced into a microfluidic device with sufficient accuracy, e.g. >1 μl. A third kind of inlet arrangement 759 that may be present comprises a volume-defining unit for metering within the device a liquid aliquot that is to be processed or otherwise used in a microchannel structure. This inlet arrangement is typically present for smaller aliquots that cannot be dispensed with sufficient accuracy, i.e. requires metering within the device. These aliquots are typically <1 μl. Valves 760, 761, 762 and 763 may be located at a) the outlet microconduit 753, for instance in an upwardly directed part and at a level below the level of the surface 755 of a liquid placed in microchamber 705, b) between a pre-collecting microcavity 764 and microchamber 705, c) at the outlet ends of various inlet arrangements 758, 759 that comprises an inlet port 765, 766 for introduction of liquid. Similarly to the structure of FIG. 6 there are also vents 777-780 to assist in smooth introduction of liquid into the various parts with minimized risk for formation of undesired bubbles. Valves are preferably non-closing with further preferences as outlined for other structures.

In use of structure 7 the magnetic particles will be collected in the pocket 706 after they have been subjected to controlled movement as discussed herein. Upon further increasing the spin speed, liquid will pass over valve 760 and drawn by capillary force over the upper extreme 754 and siphoned into the waste chamber 763 while the particles will be retained in the pocket.

The present invention is not limited to the above-described preferred embodiments. Various alternatives, modifications and equivalents may be used. Therefore, the above described embodiments should not be taken as limiting the scope of the invention, which is defined by the appended claims.

I claim:

1. A method for controlling the movement of magnetic particles in a microchamber of a microchannel structure of a microfluidic device which is spinnable about a spin axis, wherein said microchamber has a) a liquid inlet, and b) an outlet for excess air which outlet possibly also functions as an inlet or outlet for liquid, comprising the steps of:
i) providing said microfluidic device with said magnetic particles and a liquid phase being placed in said microchamber;
ii) providing a magnetic field that is
(A) capable of encompassing the microchamber when the device is spun, and
(B) directed such that the particles when placed in the microchamber are attracted inwards when the microchamber is encompassed by the magnetic field,
iii) performing a predetermined number of times a sequence of substeps (a) and (b), or (b) and (a), where:
substep (a) comprises moving the particles outwards by spinning the device at a speed that creates a sufficient centrifugal force for outbalancing the magnetic force that tends to pull the particles inwards, and
substep (b) comprises moving the particles inwards by spinning the device at a speed that creates a centrifugal force that is outbalanced by the magnetic force that tends to pull the particles inwards;
making it possible to control the particle movement into and out of a first pocket that is part of the microchamber.

2. The method of claim 1, wherein said particles are provided within said pocket and that step (iii) starts with substep (b).

3. The method of claim 1, wherein said particle movement ends in placing the particles in said first pocket.

4. The method of claim 1, wherein said particle movement ends in placing said particles in a second pocket that is physically separated from said first pocket and part of said microchamber.

5. The method of claim 1, wherein the magnetic field is created by a set I magnet(s) that are placed at radial position(s) that is/are equal to or closer to the spin axis than the radial position of the outermost part of the microchamber.

6. The method according to claim 5, wherein one or more of the magnets of set I are physically separated from the device.

7. The method according claim 6, wherein set I comprises two or more magnets and is divided into two subsets, one of which subset Iₐ is placed on one side of the device while the other subset I_{b} is placed on the opposite side of the device.

8. The method according to claim 1, wherein the liquid phase comprises two or more liquids that have been homogeneously mixed prior to step (iii).

9. The method of claim 1, wherein substep (b) comprises moving the particles within the microchamber in a positive angular direction in relation to the spin axis by spinning the device in a clockwise manner.

10. The method of claim 1, wherein substep (b) comprises moving the particles within the microchamber in a negative angular direction in relation to the spin axis by spinning the device in a counter-clockwise manner.

11. The method of claim 1, wherein the spin direction is reversed each time substep (b) is repeated.

12. The method of claim 1, wherein a liquid outlet is associated with a pocket that is part of said microchamber.

13. The method of claim 1, wherein the microchamber comprises a liquid outlet that is separated from a pocket that is part of said microchamber.

14. The method of claim 1, wherein the particles that have been moved to a pocket that is part of the microchamber are further processed with a second liquid.

15. The method of claim 1, wherein said particles carry an immobilized reactant R₁ and said liquid phase a dissolved reactant R₂ which reactants are reactive with each other (reactive counterparts to each other).

16. The method of claim 15, wherein said reactants R₁ and R₂ are members of an affinity pair, selected from:
a) components of a catalytic system;
b) members of a receptor-ligand pair;
c) complementary nucleic acids; and
d) ligands and cell receptors.

17. A system for controlling the movement of magnetic particles in a microchamber of a microchannel structure of a microfluidic device, wherein said microchamber has a) a liquid inlet, b) an outlet for excess air which outlet possibly also functions as an inlet or outlet for liquid, and c) contains a liquid phase, said microfluidic device is spinnable about a spin axis when put on a spinner station that is controlled by a controller, wherein one or more magnets that are placed, fixed or movable, in close connection to the spinning plane of the microfluidic plane, said one or more magnets provide a magnetic field that is
(A) capable of encompassing the microchamber when the device is spun, and
(B) directed such that the particles are attracted inwards when the microchamber is encompassed by the magnetic field,
said controller is capable by means of computer program instructions to control the performance of a sequence of substeps (a) and (b), or (b) and (a) a predetermined number of times, where:
substep (a) comprises moving the particles outwards by spinning the device at a speed that creates a sufficient centrifugal force for outbalancing the magnetic force that tends to pull the particles inwards, and
substep (b) comprises moving the particles inwards by spinning the device at a speed that creates a centrifugal force that is outbalanced by the magnetic force that tends to pull the particles inwards;
said sequence making it possible to control the particle movement into and out of a pocket that is associated with said microchannel structure.

18. The system according to claim 17, wherein the magnetic field is created by a set I magnet(s) that are placed at radial position(s) that is/are equal to or closer to the spin axis than the outermost part of the microchamber.

19. The system according to claim 18, wherein one or more of the magnets of set I are physically separated from the device.

20. The system according to claim 18, wherein set I comprises two or more magnets and is divided into two subsets, one of which subset Iₐ is placed on one side of the device while the other one subset I_{b} is placed on the opposite side of the device.

21. The system according to claim 17, wherein the liquid phase contains two or more homogeneously mixed liquids.

22. The system according to claim 17, wherein the controller is capable of causing the spin to be clockwise in substep (b) thereby moving the particles within the microchamber in a positive angular direction.

23. The system according to claim 17, wherein the controller is capable of causing the spin to be counter-clockwise in substep (b) thereby moving the particles within the microchamber in a positive angular direction.

24. The system according to claim 17, wherein the controller is capable of reversing the spin direction each time substep (b) is repeated.

25. The system according to claim 17, wherein a liquid outlet is associated with said pocket.

26. The system according to claim 17, wherein the microcavity comprises a liquid outlet that is separated from said pocket.

27. The system according to claim 17 wherein the controller is capable of causing further processing of particles that have been moved to the pocket with a second liquid.

28. The system according to claim 17, wherein said particles carry an immobilized reactant R₁ and said liquid phase a dissolved reactant R₂ which reactants are reactive with each other (reactive counterparts to each other).

29. The method according to claim 6, wherein all of the magnets of set I are physically separated from the device.

30. The method of claim 16, wherein said reactants R₁ and R₂ are components of a biocatalytic system.

31. The method of claim 30, wherein said reactants R₁ and R₂ are components of an enzyme system.

32. The method of claim 16, wherein said reactants R₁ and R₂ are an antigen/hapten and an antibody.

33. The method of claim 16, wherein said reactants R₁ and R₂ are cell surface structures and soluble or dissolved substances that are capable of interacting with the structures.

34. The method of claim 16, wherein said reactants R₁ and R₂ are ligands and cell receptors, which further include synthetic reactants that mimetics of native reactants that can participate in bioaffinity reactions.

35. The method according to claim 19, wherein all of the magnets of set I are physically separated from the device.
